(19) United States
(12) Patent Application Publication
(10) Pub. No.: US 2011/0130088 A1
(43) Pub. Date: Jun. 2, 2011

(54) RELAY STATION APPARATUS, MULTIHOP SYSTEM AND RELAYING METHOD

(76) Inventor: Tetsu Ikeda, Tokyo (JP)

(21) Appl. No.: 13/056,266

(22) PCT Filed: Aug. 10, 2009
(86) PCT No.: PCT/JP2009/064116

§ 371 Date: Jan. 27, 2011

(30) Foreign Application Priority Data
Sep. 11, 2008 (JP) 2008-233393

(51) Int. Cl. H04B 3/36

(52) U.S. Cl. 455/7

(57) ABSTRACT

A relay apparatus includes a first transmission/receiving means and second transmission/receiving means. The first transmission/receiving means exchanges a first relay link signal of a first frequency transmitted/received by a superordinate apparatus, with the superordinate apparatus and exchanges part of the first relay link signal as a second access link signal or a second relay link signal, at the first frequency, with a subordinate apparatus. The second transmission/receiving means exchanges the other part of the first relay link signal, which the first transmission/receiving means exchanges with the superordinate apparatus, as a third access link signal or a third relay link signal, at a second frequency that is different from the first frequency, with a subordinate apparatus.

### TECHNICAL FIELD

The present invention relates to a multihop system that relays signals between a terminal and a base station apparatus by multiple hops of radio links.

### BACKGROUND ART

In WiMAX (Worldwide Interoperability for Microwave Access), there are cases in which relay stations are disposed between a terminal apparatus and a base station apparatus so as to relay signals by multiple hops of radio links. The system that relays signals between a terminal apparatus and a base station apparatus through multiple hops of radio links is generally called a multihop system.

Use of a multihop system makes it possible to cover a dead zone created by an obstruction, the underground and other areas by use of relay stations. Further, in the multihop system, it is possible to obtain a better communication status in each radio link than that when a terminal apparatus and a base station apparatus are connected directly. As a result, it is possible to use a modulation scheme having high frequency usage efficiency, hence this enhances the frequency usage efficiency of the whole system.

Under the circumstances as above, multiple kinds of frame formats have been proposed in WiMAX, dealing with the possibility of application modes of various multihop systems (see IEEE C802. 16j-08/079r1, “Out-of-band relay clarification”, UKB, NEC, etc., 2008/3/18 (to be referred to hereinbelow as Document 1).

According to Document 1, it is presumed that a frame format shown in FIG. 2 is applied to the multihop system having a configuration shown in FIG. 1. The multihop system in FIG. 1 includes base station apparatus BS and relay station apparatus RS. Mobile terminal MS is connected to base station apparatus BS via relay station apparatus RS. Mobile terminal MS can also be connected directly to base station apparatus BS.

Relay station apparatus RS of this multihop system is equipped with transmitter/receiver for a relay link for connection to base station apparatus BS and for access links for connection to mobile station apparatuses MS. The frequency f1 is used for relay links, the frequency f2 is used for access links.

In a time division multiplexing WiMAX system, uplink signals and downlink signals are divided in the time domain. In this multihop system, uplink signals and down link signals are relayed by relay station apparatus RS.

Referring to the frame format in FIG. 2, the downlink signals and the uplink signals of base station apparatus BS are temporally divided into an access zone (AZ: Access Zone) for direct access to mobile station apparatus MS and a relay zone (RZ: Relay Zone) for connection to relay station apparatus RS. The access link signals are transmitted in the access zone and the relay link signals are transmitted in the relay zone. Relay station apparatus RS establishes connection with base station apparatus BS by relay links and establishes connection with mobile terminal MS by access links. Relay station apparatus RS transmits the downlink signal received from base station apparatus BS by relay links, to mobile terminal MS by access links. Also, relay station apparatus RS transmits the uplink signal received from mobile terminal MS by access links, to base station apparatus BS by relay links.

In accordance with this configuration, relay station apparatus RS covers the communication area around the relay apparatus RS, whereby it is possible for base station apparatus BS to accommodate mobile terminals MS with high frequency usage efficiency.

### DISCLOSURE OF INVENTION

### Problems to be Solved by the Invention

In relay station apparatus RS in the multihop system shown in FIGS. 1 and 2, two branches of radio links were used for different tasks, that is, the relay link was used for connection to base station apparatus BS and the access link was used for connection to mobile terminal MS. However, the branch for the relay link is only used during the time periods of relay zone RZ in base station apparatus BS whereas it is not used during the time periods of access zone, meaning that the resource cannot be efficiently used.

The object of the present invention is to provide a technology for constructing a multihop system that can accommodate terminal apparatuses with higher efficiency.

### Means for Solving the Problems

In order to attain the above object, a relay station apparatus according to the present invention includes:

first transmission/receiving means that exchanges a first relay link signal of a first frequency transmitted/received by a superordinate apparatus, with the superordinate apparatus and exchanges part of the first relay link signal as a second access link signal or a second relay link signal, at the first frequency, with a subordinate apparatus; and,

second transmission/receiving means that exchanges the other part of the first relay link signal, which the first transmission/receiving means exchanges with the superordinate apparatus, as a third access link signal or a third relay link signal, at a second frequency that is different from the first frequency, with a subordinate apparatus.

A multihop system of the present invention includes:

a base station apparatus that transmits/receives a relay link signal for establishing connection with a terminal apparatus in multihops; and,

a relay station apparatus including first transmission/receiving means and second transmission/receiving means, the first transmission/receiving means exchanging a first relay link signal of a first frequency with the base station apparatus or with another relay station as a superordinate apparatus and exchanging part of the first relay link signal as a second access link signal or a second relay link signal, at the first frequency, with a terminal apparatus or another relay station as a subordinate apparatus, and, the second transmission/receiving means exchanging the other part of the first relay link signal, which the first transmission/receiving means exchanges with the superordinate apparatus, as a third access link signal or a third relay link signal, at a second frequency that is different from the first frequency, with a subordinate apparatus.

A relaying method of the present invention is a relaying method in a relay station apparatus of a multihop system for connecting between a base station apparatus and a terminal apparatus in multihops, comprising the steps of:

by means of first transmission/receiving means provided for the relay station apparatus, exchanging a first relay link signal of first frequency signals that are transmitted or received by the base station apparatus or by another relay station as a superordinate apparatus, with the superordinate apparatus and exchanging part of the first relay link signal as a second access link signal or a second relay link signal, at the first frequency, with a terminal apparatus or another relay station as a subordinate apparatus, and,

by means of second transmission/receiving means provided for the relay station apparatus, exchanging the other part of the first relay link signal which the first transmission/receiving means exchanges with the superordinate apparatus, as a third access link signal or a third relay link signal, at a second frequency that is different from the first frequency, with a subordinate apparatus.

### BRIEF DESCRIPTION OF THE DRAWINGS

FIG. 1 is a block diagram showing a configuration of a multihop system based on a proposal.

FIG. 2 is a diagram showing a frame format used in the multihop system in FIG. 1.

FIG. 3 is a block diagram showing a configuration of a multihop system according to the present exemplary embodiment.

FIG. 4 is a block diagram showing a configuration of relay station apparatus RS of the present exemplary embodiment.

FIG. 5 is a diagram showing a frame format used in a multihop system of the present exemplary embodiment.

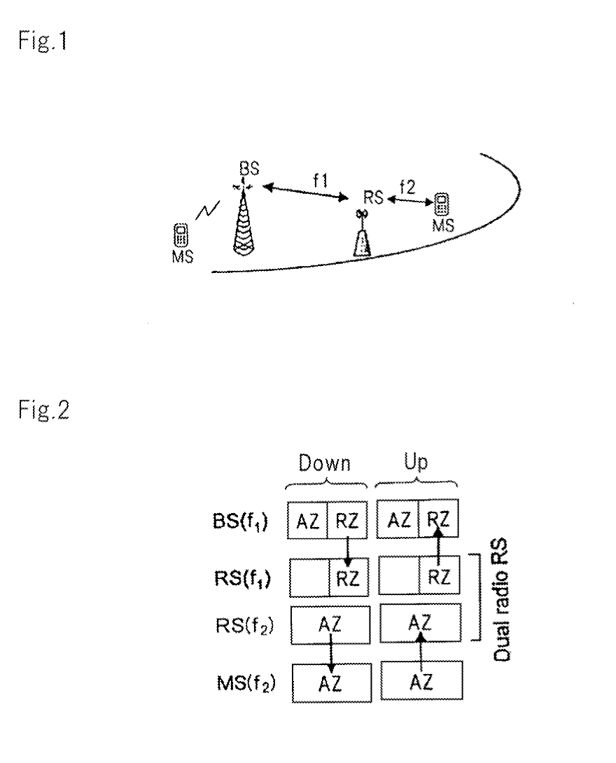

### BEST MODE FOR CARRYING OUT THE INVENTION

The mode for carrying out the present invention will be described in detail with reference to the drawings.

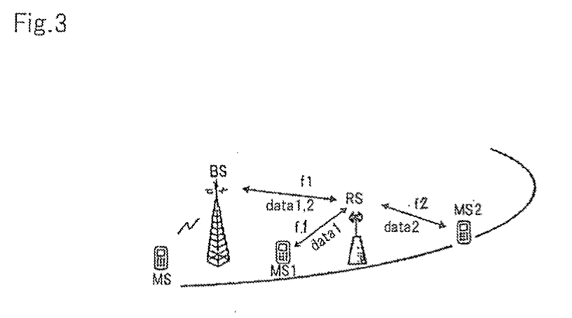

FIG. 3 is a block diagram showing a configuration of a multihop system according to the present exemplary embodiment. Referring to FIG. 3, the multihop system of the present exemplary embodiment includes base station apparatus BS and relay station apparatus RS.

Base station apparatus BS is an apparatus that connects mobile terminals MS to an unillustrated backbone network. Base station apparatus BS directly connects to mobile terminal MS by an access link and connects to mobile terminal MS through relay station apparatus RS that is connected by a relay link.

A relay link is a radio link for relaying signals between the base station apparatus and a relay station apparatus or between relay station apparatuses in this multihop system, and is a radio link between base station apparatus BS and relay station apparatus RS in this exemplary embodiment. A plurality of hops of relay station apparatuses RS may be deployed between base station apparatus BS and mobile terminal MS so as to realize relaying three or more hops.

An access link is a radio link by which the present multihop system, as a radio access network, accommodates mobile terminal MS, and is a radio link that connects between base station apparatus BS or relay station apparatus RS and mobile terminal MS in the example of the exemplary embodiment.

Relay station apparatus RS is an apparatus that is disposed between base station apparatus BS and mobile terminal MS (MS1, 2) to relay signals, is connected to base station apparatus BS by a relay link and connects to mobile terminal MS by an access link. Relay station apparatus RS in the present exemplary embodiment includes two branches of transmitter/receivers, and relays data 1 and data 2 to be transmitted through the relay link between base station apparatus BS and relay station apparatus RS, to the access links of transmitter/receivers that are different from each other. One of the two branches of transmitter/receivers is also used for connection of the relay link with base station apparatus BS. In this example, the access link of data 2 and the relay link share the same branch of the transmitter/receiver. The branch for connecting the access link of data 2 and the relay link with base station apparatus BS uses frequency f1. The branch for connecting the access link of data 1 uses frequency f2, which is different from frequency f1.

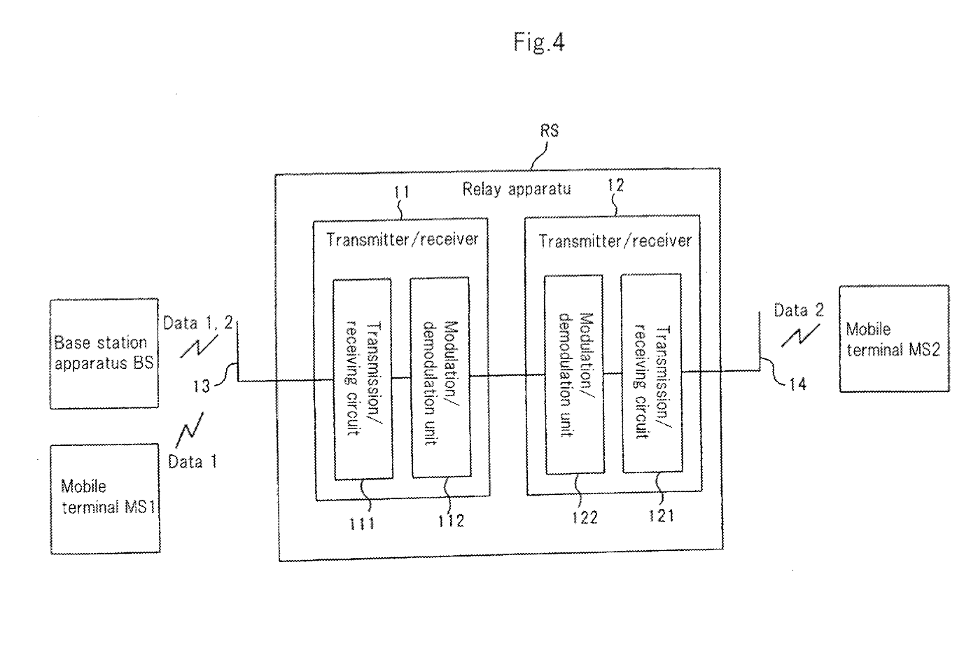

FIG. 4 is a block diagram showing a configuration of relay station apparatus RS of the present exemplary embodiment. Referring to FIG. 4, relay station apparatus RS includes transmitter/receivers 11 and 12.

Transmitter/receiver 11 exchanges relay link signals with base station apparatus BS (data 1 and 2), with base station apparatus BS. Transmitter/receiver 11 also exchanges part of the relay link signals (data 1) with mobile terminal MS1 by the access link.

Transmitter/receiver 11 includes transmission/receiving circuit 111 and modulation/demodulation unit 112. Transmission/receiving circuit 111 exchanges radio signals of frequency f1 with base station apparatus BS and mobile terminal MS1 via antenna 13. Modulation/demodulation unit 112 modulates and demodulates signals transmitted/received by transmitter/receiver circuit 111.

The downlink signals transmitted by base station apparatus BS and the uplink signals received by base station apparatus BS are time-division multiplexed. In each of the uplink and the downlink signals, relay link signals and access link signals that are to be directly connected between base station apparatus BS and the mobile terminal are time-division multiplexed so that they are distributed to different zones from each other. Transmitter/receiver 11 exchanges access link signals with mobile terminal MS1 in the zone through which base station apparatus BS exchanges access link signals.

Transmitter/receiver 12 is provided separately from transmitter/receiver 11, and exchanges another part (data 2) of the relay link signals that are exchanged with base station apparatus BS by transmitter/receiver 11, with mobile terminal MS2 by the access link. Transmitter/receiver 12 includes transmission/receiving circuit 121 and modulation/demodulation unit 122. Transmission/receiving circuit 121 exchanges radio signals of frequency f2 with mobile terminal MS2 via antenna 14. Modulation/demodulation unit 122 modulates and demodulates signals transmitted/received by transmitter/receiver circuit 121.

For easy understanding, shown is an example in which an antenna is provided for each branch such that antenna 13 is provided for the branch of transmitter/receiver 11 while antenna 14 is provided for the branch of transmitter/receiver 12. However, other than the configuration herein, there is a configuration in which transmitter/receiver 11 and transmitter/receiver 12 are connected to a single antenna via a duplexer.

Since different frequencies are used in transmitter/receiver 11 and transmitter/receiver 12, the communication area in which mobile terminal MS1 is connected by transmitter/receiver 11 and the communication area in which mobile terminal MS2 is connected by transmitter/receiver 12 may overlap each other.

In the present system, an adaptive modulation method in which the scheme of modulation varies depending on the status of the radio channel is used. In modulation/demodulation units 112 and 122, a plurality of modulation schemes that differ in characteristics such as, for example QAM and QPSK are supported. The modulation scheme having the higher frequency usage efficiency is used when the status of the radio channel is relatively good, whereas the modulation scheme that is robust against errors is used when the status of the radio channel is relatively poor.

In downlink, modulation/demodulation unit 112 demodulates the relay link signal (data 1 and 2) that was received from base station apparatus BS at transmission/receiving circuit 111, based on the modulation scheme used for that signal, and part of the data (data 1) of the signal obtained after demodulation is re-modulated based on a new modulation scheme so that the modulated signal is transmitted to mobile terminal MS1 via transmission/receiving circuit 111. The other part (data 2) of the signal obtained after demodulation by modulation/demodulation unit 112 is modulated by modulation/demodulation unit 122 based on a new modulation scheme, so that the modulated signal is transmitted to mobile terminal MS2 via transmission/receiving circuit 121.

In uplink, modulation/demodulation unit 122 demodulates the access link signal (data 2) that was received from mobile terminal MS2 at transmission/receiving circuit 121, based on the modulation scheme used for that signal. Modulation/demodulation unit 112 demodulates the access link signal (data 1) that was received from mobile terminal MS1 by transmission/receiving circuit 111, based on the modulation scheme used for that signal. Then, modulation/demodulation unit 112 modulates the signal obtained by demodulation thereof and the signal obtained by demodulation by modulation/demodulation unit 122, based on the new modulation scheme and transmits the modulated signals to base station apparatus BS via transmission/receiving circuit 111.

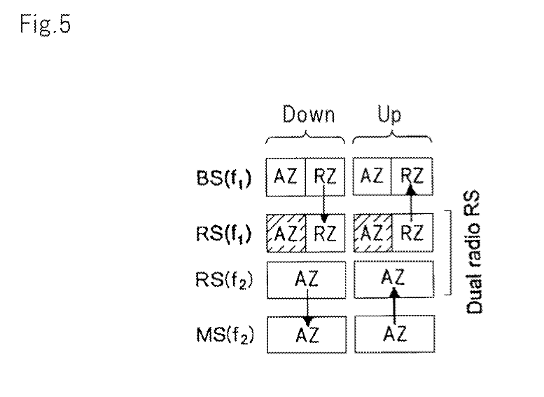

FIG. 5 is a diagram showing a frame format used in a multihop system of the present exemplary embodiment. Referring to the frame format in FIG. 5, the frames transmitted and received by base station apparatus BS are temporally divided into access zones (AZ: Access Zone) for direct connection to mobile terminals MS, relay zones (RS: Relay Zone) for connection to relay station apparatus RS. Access link signals are transmitted in access zones and relay link signals are transmitted in relay link zones.

In the frame transmitted and received by transmitter/receiver 11 of relay station apparatus RS, the access link signal transmitted to mobile station MS1 or received from mobile station MS1 and the relay link signal transmitted to base station apparatus BS or received from base station apparatus BS are time-division multiplexed. The access link signal in the frame transmitted and received by transmitter/receiver 11 is allocated in the access zone.

As described heretofore, according to the present exemplary embodiment, relay station apparatus RS includes two transmitter/receivers 11 and 12, and exchanges access link signals with radio terminal MS2 by means of transmitter/receiver 12, and in addition, uses transmitter/receiver 11 that exchanges relay link signals with base station apparatus BS to exchange access link signal with mobile station MS1. Accordingly, it is possible to construct a multihop system that can accommodate mobile terminals MS more efficiently. Further, since different frequencies are used by transmitter/receiver 11 and transmitter/receiver 12, the communication area in which mobile terminal MS1 is connected by transmitter/receiver 11 and the communication area in which mobile terminal MS2 is connected by transmitter/receiver 12 can be made to overlap each other. As a result, this enables a flexible area design. Further, since scheduling can be carried out using relay links of different frequencies, the flexibility of scheduling can be improved. As a result, it is possible to perform scheduling that can suppress interference more efficiently.

Further, according to the present exemplary embodiment, relay station apparatus RS exchanges access link signals with mobile terminal MS1 in the access zone, using transmitter/receiver 11. Accordingly, it is possible to make efficient use of access zones for time-division multiplexing to accommodate mobile terminals.

Further, when mutually joining the relay link signal exchanged with base station apparatus BS by transmitter/receiver 11 and the access link signal exchanged with mobile terminal MS by transmitter/receiver 11 or by transmitter/receiver 12, relay station apparatus RS demodulates the signals once and then re-modulates the signals based on a new modulation scheme, in accordance with an adaptive modulation method. The quality of radio channel of each radio link in the multihops is improved in compared to the radio link when mobile terminal MS is directly connected to base station apparatus BS. Since a modulating scheme suited to the status of the radio channel is selected in the adaptive modulation method, the modulation scheme that has the high frequency usage efficiency in each radio link in the multihops is used. As a result, improved frequency usage efficiency can be obtained so that in each of the communication areas covered by transmitter/receiver 11 and transmitter/receiver 12, it is possible to accommodate mobile terminals MS more efficiently.

Since the signals are once demodulated at transmitter/receiver 11 and transmitter/receiver 12 and re-modulated based on a new modulation scheme, the modulation scheme on the relay link between base station apparatus BS and relay station apparatus RS and the modulation scheme on the access links between relay station apparatus RS and mobile terminals MS1 and MS2 are selected independently. If a cell design is planned so that the channel quality of the relay link between base station apparatus BS and relay station apparatus RS will become better than the channel quality of the access links between relay station apparatus RS and mobile terminals MS1 and MS2, the adaptation of transmitter/receiver 11 to exchange access link signals with mobile terminal MS1 when it does not exchange relay link signals with base station apparatus BS, makes it possible to fully use the expanded band for access links, thus resulting in accommodating mobile terminals in a further efficient manner.

Further, the present exemplary embodiment was illustrated taking an example where base station apparatus BS includes one branch for frequency f1 and this branch is used for both the access link and the relay link, as shown in FIG. 5. However, the present invention should not be limited to this example. As another example, base station apparatus BS may include another branch for frequency f2 so that the branch may be used to transmit and receive access link signals.

As the exemplary embodiment of the present invention has been described heretofore, the present invention should not be limited to this exemplary embodiment, but the configurations may be combined and part of the configuration may be modified within the technical scope of the present invention.

This application claims priority, based on Japanese Patent Application 2008-233393 filed on Sep. 11, 2008, and should incorporate all the disclosure thereof herein.

1. A relay station apparatus comprising:
a first transmission/receiving unit that exchanges a first relay link signal of a first frequency transmitted/received by a superordinate apparatus, with the superordinate apparatus and exchanges part of the first relay link signal as a second access link signal or a second relay link signal, at the first frequency, with a subordinate apparatus; and,
a second transmission/receiving unit that exchanges the other part of the first relay link signal, which the first transmission/receiving unit exchanges with the superordinate apparatus, as a third access link signal or a third relay link signal, at a second frequency that is different from the first frequency, with a subordinate apparatus.

2. The relay station apparatus according to claim 1, wherein the first relay link signal transmitted/received by the superordinate apparatus and the first access link signal which the superordinate apparatus directly exchanges with a subordinate apparatus are time-division multiplexed so as to be allocated to zones that are different from each other, and,
the first transmission/receiving unit transmits/receives the second access link signal or the second relay link signal, in the zone in which the superordinate apparatus transmits/receives the first access link signal.

3. The relay station apparatus according to claim 1, wherein the first transmission/receiving unit and the second transmission/receiving unit demodulate a received signal and modulate a signal to be transmitted based on an adaptive modulation scheme.

4. A multihop system comprising:
a base station apparatus that transmits/receives a relay link signal for establishing connection with a terminal apparatus in multihops; and,
a relay station apparatus including a first transmission/receiving unit and a second transmission/receiving unit, the first transmission/receiving unit exchanging a first relay link signal of a first frequency with the base station apparatus or with another relay station as a superordinate apparatus and exchanging part of the first relay link signal as a second access link signal or a second relay link signal, at the first frequency, with a terminal apparatus or with another relay station as a subordinate apparatus, and, the second transmission/receiving unit exchanging the other part of the first relay link signal, which the first transmission/receiving unit exchanges with the superordinate apparatus, as a third access link signal or a third relay link signal, at a second frequency that is different from the first frequency, with a subordinate apparatus.

5. The multihop system according to claim 4, wherein the first relay link signal transmitted/received by the superordinate apparatus and the first access link signal which the superordinate apparatus transmits or receives are time-division multiplexed so as to be allocated to zones that are different from each other, and,
the first transmission/receiving unit transmits/receives the second access link signal or the second relay link signal, in the zone in which the superordinate apparatus transmits and receives the first access link signal.

6. The multihop system according to claim 4, wherein the first transmission/receiving unit and the second transmission/receiving unit demodulate a received signal and modulate a signal to be transmitted based on an adaptive modulation scheme.

7. A relaying method in a relay station apparatus of a multihop system for connecting between a base station apparatus and a terminal apparatus in multihops, comprising the steps of:
by means of a first transmission/receiving unit provided for the relay station apparatus, exchanging a first relay link signal of first frequency signals that are transmitted or received by the base station apparatus or by another relay station as a superordinate apparatus, with the superordinate apparatus and exchanging part of the first relay link signal as a second access link signal or a second relay link signal, at the first frequency, with a terminal apparatus or another relay station as a subordinate apparatus, and,
by means of a second transmission/receiving unit provided for the relay station apparatus, exchanging the other part of the first relay link signal which the first transmission/receiving unit exchanges with the superordinate apparatus, as a third access link signal or a third relay link signal, at a second frequency that is different from the first frequency, with a subordinate apparatus.

8. The relaying method according to claim 7, wherein the first relay link signal transmitted/received by the superordinate apparatus and the first access link signal which the superordinate apparatus transmits or receives are time-division multiplexed so as to be allocated to zones that are different from each other, and,
the first transmission/receiving unit transmits/receives the second access link signal or the second relay link signal, in the zone in which the superordinate apparatus transmits/receives the first access link signal.

9. The relaying method according to claim 7, wherein the first transmission/receiving unit and the second transmission/receiving unit demodulate a received signal and modulate a signal to be transmitted based on an adaptive modulation scheme.
